(19) United States
(12) Patent Application Publication
(10) Pub. No.: US 2024/0317186 A1
(43) Pub. Date: Sep. 26, 2024

(54) DEVICE FOR CLEANING AN OPTICAL ELEMENT OF A MOTOR VEHICLE, OPTICAL ELEMENT AND CORRESPONDING CLEANING METHOD

(71) Applicant: Valeo Systèmes d'Essuyage, Le Mesnil Saint Denis (FR)

(72) Inventor: Radu-George Bute, Bietigheim-Bissingen (DE)

(73) Assignee: Valeo Systèmes d'Essuyage, Le Mesnil Saint Denis (FR)

(21) Appl. No.: 18/276,749

(22) PCT Filed: Feb. 11, 2022
(86) PCT No.: PCT/EP2022/053443

§ 371 Date: Aug. 10, 2023

(30) Foreign Application Priority Data
Feb. 11, 2021 (FR) 2101301

(51) Int. Cl. B60S 1/54; B60S 1/52; B60S 1/56

(52) U.S. Cl. CPC B60S 1/54; B60S 1/52; B60S 1/56

(57) ABSTRACT

Cleaning device for an optical element designed to equip a motor vehicle, the cleaning device having a base configured to be arranged on at least one of the sides of the lens of the optical element, the base comprising an air duct circulating a jet of air between an air intake and an air outlet arranged inside the base, the air outlet projecting from the base and forming a first air ejection nozzle arranged on the periphery of the lens of the optical element and configured to project a jet of air onto the surface of the lens. A pipe for liquid, coupled to the base, circulates a cleaning liquid between an inlet and an outlet for liquid, the outlet for liquid projecting from the base and forming a second liquid ejection nozzle arranged on the periphery of the lens of the optical element and configured to project a jet of cleaning liquid onto the surface of the lens.

The present invention relates to the field of cleaning devices in the automotive sector. More particularly, the present invention relates to a cleaning device for an optical element intended to be fitted to a motor vehicle.

With the development of driving or parking assistance systems, motor vehicles are increasingly being fitted with optical elements such as cameras. However, these optical elements, or at least the surface of their lenses, are placed on the outside of the vehicle and are exposed to bad weather and dirt that may degrade their vision. A known solution is to dispose, in the vicinity of the surface of the lens of the optical element, a cleaning liquid sprinkler that is able to spray this surface in order to rid it of dirt and dust. However, depending on the position of the optical element on the vehicle, droplets of cleaning liquid or even dirt may remain on the surface of the lens.

One of the aims of the present invention is therefore to at least partially overcome the drawbacks of the prior art and to propose an improved optical element cleaning device.

The present invention therefore relates to a cleaning device for an optical element notably intended to be fitted to a motor vehicle, said cleaning device comprising a base configured to be disposed on at least one of the sides of the lens of the optical element, said base comprising an air line in which a jet of air is intended to circulate between an air intake and an air outlet which are provided within said base, the air outlet protruding from the base and forming a first, air ejection nozzle which is disposed at the periphery of the lens of the optical element and which is configured to project a jet of air onto the surface of the lens, the cleaning device further comprising a liquid line which is coupled to the base and in which a cleaning liquid is intended to circulate between a liquid inlet and a liquid outlet, the liquid outlet protruding from the base and forming a second, liquid ejection nozzle which is disposed at the periphery of the lens of the optical element and which is configured to project a jet of cleaning liquid onto the surface of the lens.

In certain embodiments, the base comprises at least one curved portion configured to surround at least a part of the lens.

It will be appreciated that the base and the lens are concentric.

For example, the base is configured to surround the entire lens.

For example, the base has a cylindrical shape.

For example, the lens is disposed at least partially inside the base. For example, the optical element is disposed at least partially inside the base.

Thus, the base may also act as protective housing for the optical element and/or for the lens.

According to one aspect of the invention, the air outlet of the first nozzle and the liquid outlet of the second nozzle are disposed with respect to one another in such a way that the relative direction of ejection of the liquid forms an angle of between 7° and 110° with respect to the relative direction of ejection of the jet of air.

According to another aspect of the invention, the air outlet is configured such that the jet of air is an air knife, the air outlet having the shape of a slot.

For example, the air ejection nozzle is disposed in the continuation of at least a part of the base.

For example, the air ejection nozzle is disposed around a part of the circumference of the lens.

For example, the air outlet nozzle has a concave shape.

For example, the air outlet nozzle extends over a curved portion having the center of the lens as its center of curvature.

For example, the air outlet nozzle has the shape of an arc of a circle having, for example, a center coincident with the center of the lens, the arc of a circle being delimited by the ends of the nozzle in a circumferential direction.

For example, the angle at the center of the arc of a circle is between 1° and 110°.

For example, the angle at the center of the arc of a circle is between 45 and 100°.

For example, the angle at the center of the arc of a circle is between 6° and 90°.

For example, the angle at the center of the arc of a circle is between 75° and 100°.

According to another aspect of the invention, the cleaning device is configured to adapt around a circular lens, the base being curved and having an axis of curvature configured to be concentric with the axis of revolution of the lens of the optical element.

According to another aspect of the invention, the relative direction of ejection of the liquid and the relative direction of ejection of the jet of air both pass through the axis of curvature of the base.

According to another aspect of the invention, the base has the shape of an arc of a circle configured to partially surround the lens of the optical element.

According to another aspect of the invention, the base has a circular shape configured to completely surround the lens of the optical element.

According to another aspect of the invention, the base is configured such that only the air outlet and the liquid outlet project beyond the plane formed by the surface of the lens of the optical element.

According to another aspect of the invention, the cleaning device comprises a supply tube connected, for the one part, to the air intake of the base, and, for the other part, to a blower.

According to another aspect of the invention, the liquid inlet of the base comprises a device for connecting to a circuit for circulating a cleaning liquid of the motor vehicle.

The present invention also relates to an optical element comprising a cleaning device as described above.

The present invention also relates to a method for cleaning an optical element, said cleaning method comprising the following steps:
a first step of projecting a jet of air continuously onto the surface of the lens by way of the air outlet,
a second step of projecting a jet of cleaning liquid onto the surface of the lens by way of the liquid outlet, during this second step, the intensity of the jet of air decreases,
a third step, during which the jet of liquid is interrupted and the jet of air picks up in intensity, said jet of air being maintained until a new second step of ejecting cleaning liquid.

Further features and advantages of the present invention will become more clearly apparent from reading the following description, which is given by way of non-limiting illustration, and with reference to the accompanying drawings, in which:

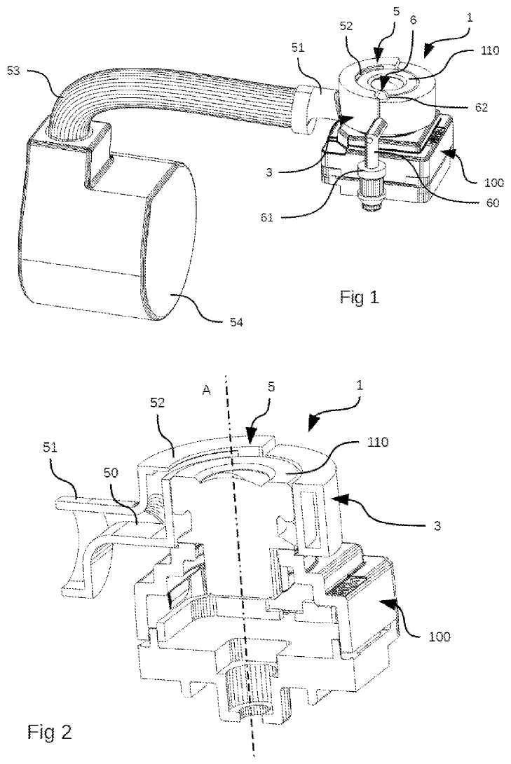

FIG. 1 shows a schematic perspective depiction of a cleaning device,

FIG. 2 shows a schematic perspective depiction in cross section of the cleaning device in FIG. 1,

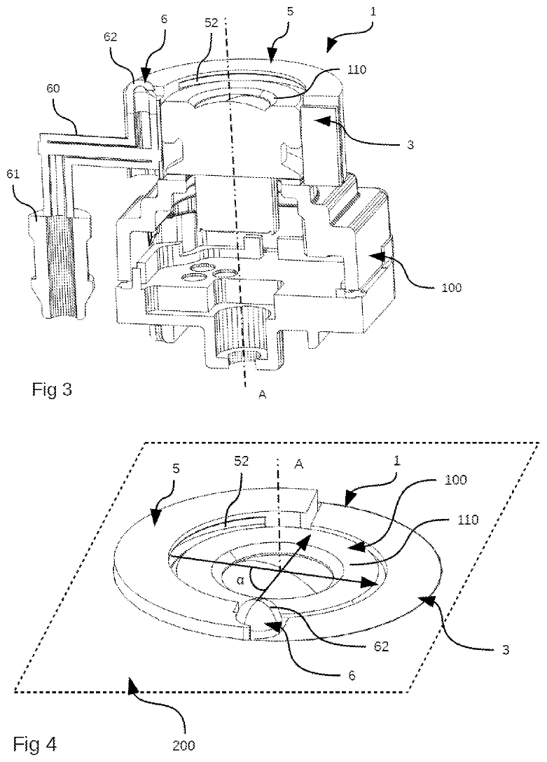

FIG. 3 FIG. 2 shows a schematic perspective depiction in cross section of the cleaning device in FIG. 1 according to a different angle,

FIG. 4 shows a schematic perspective depiction of the surface of a bodywork element fitted with an optical element and with a cleaning device,

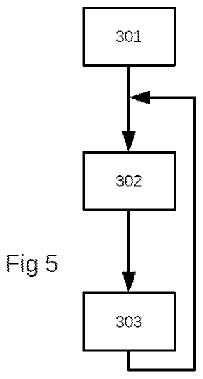

FIG. 5 shows a flow diagram of the steps of a method for cleaning an optical element.

In these figures, identical elements bear the same reference numerals.

The following embodiments are examples. Although the description refers to one or more embodiments, this does not necessarily mean that each reference relates to the same embodiment, or that the features apply only to one embodiment. Individual features of different embodiments may also be combined and/or interchanged to provide other embodiments.

In the present description, certain elements or parameters may be indexed, for example first element or second element and also first parameter and second parameter or first criterion and second criterion, etc. In this case, this is simply indexing to differentiate and designate elements or parameters or criteria that are similar but not identical. This indexing does not imply priority being given to one element, parameter or criterion over another and such designation may be interchanged easily without departing from the scope of the present description. Neither does this indexing imply any chronological order for example in assessing any given criterion.

FIG. 1 shows a cleaning device 1 for an optical element 100. This optical element 100 may for example be a driving or parking assistance camera and is intended to be fitted to a motor vehicle. The cleaning device 1 comprises a base 3 configured to be disposed on at least one of the sides of the lens 110 of the optical element 100.

The base 3 comprises an air line 50 (visible in FIG. 2) in which a jet of air is intended to circulate between an air intake 51 and an air outlet 52 which are provided within said base 3. The air outlet 52 protrudes from the base 3 and thus forms a first ejection nozzle 5 disposed at the periphery of the lens 110 of the optical element 100. The air outlet 52 is notably configured to project a jet of air onto the surface of the lens 110.

The air outlet 52 may notably be configured such that the jet of air is an air knife. To this end, the air outlet 52 has the shape of a slot. This slot may more particularly be parallel to the surface of the lens 110 of the optical element 100 such that the air knife generated more or less grazes this surface of the lens 110.

Still according to FIG. 1, the cleaning device 1 may notably comprise a supply tube 53. This supply tube 53 is connected, for the one part, to the air intake 51, and, for the other part, to a blower 54. This blower 54 may be, for example, a dedicated blower for the generation of an air flow for one or more cleaning devices 1. This blower 54 may also be the blower of a heating, ventilation and air conditioning system of the motor vehicle.

FIG. 2 shows an optical element 100 with a cleaning device 1 in more detail. More particularly in FIG. 2, the optical element 100 and the cleaning device 1 are depicted in a cross section passing through the air line 50. As shown by FIG. 2, the air line 50 may be recessed into the base 3. The air intake 51 and the air outlet 52 are then formed integrally with the base 3.

Returning to FIG. 1, the cleaning device 1 further comprises a liquid line 60 which is coupled to the base 3 and in which a cleaning liquid is intended to circulate between a liquid inlet 61 and a liquid outlet 62. The liquid outlet 62 protrudes from the base 3 and forms a second, liquid ejection nozzle 6 which is disposed at the periphery of the lens 110 and which is configured to project a jet of cleaning liquid onto the surface of the lens 110.

FIG. 3 shows an optical element 100 with a cleaning device 1 in more detail. More particularly in FIG. 3, the optical element 100 and the cleaning device 1 are depicted in a cross section passing through the liquid line 60. As shown by FIG. 3, the liquid line 60 may be an added-on component attached to the base 3.

The liquid inlet 61 may notably comprise a device for connecting to a circuit for circulating a cleaning liquid of the motor vehicle. This connecting device may notably be a fastening end piece of a cleaning liquid pipe allowing connection to a circuit for circulating a cleaning liquid of the motor vehicle. This circulation circuit may be a dedicated circuit or be a cleaning liquid circuit of the motor vehicle that is already present, such as the cleaning liquid circuit of the windshield, of the traffic lights or of other elements of the motor vehicle. This circulation circuit may notably comprise a cleaning liquid tank, a pump in order to set the cleaning liquid in motion and one or more electrovalves in order to manage the circulation of the cleaning liquid.

The fact that the cleaning device 1 comprises both a first, air ejection nozzle 5 and a second, liquid ejection nozzle 6 makes it possible to clean the lens 110 of the optical element 100 by way of the cleaning liquid and also discharge dirt and cleaning liquid droplets by way of the jet of air. The effectiveness of the cleaning is thus improved. In addition, the fact that these two nozzles 5 and 6 are grouped together at the base 3 of the same cleaning device 1 facilitates the mounting of the cleaning device 1 on the optical element 100.

The optical element 100 along with its cleaning device 1 may thus be more easily installed together within the motor vehicle during the same mounting step.

As shown in more detail in FIG. 3, the base 3 is advantageously configured such that only the air outlet 52 and the liquid outlet 62 project beyond the plane formed by the surface of the lens 110 of the optical element 100. Thus, an orifice that is complementary to the shape of the lens 110 of the optical element 100 with the cleaning device 1 may be provided on, for example, a bodywork element 200 of the motor vehicle. The surface of the lens 110 may thus be at the same level as the surface of the bodywork element 200 and only the air outlet 52 and the liquid outlet 62 project beyond the surface of the bodywork element 200.

Preferably, the height to which the air outlet 52 and the liquid outlet 62 project is calculated so as to not enter the field of vision of the optical element 100.

The air outlet 52 of the first nozzle 5 and the liquid outlet 62 of the second nozzle 6 may more particularly be disposed with respect to one another in such a way that the relative direction of ejection of the liquid forms an angle α of between 7° and 110° with respect to the relative direction of ejection of the jet of air. Preferably, the relative direction of ejection of the liquid and the relative direction of ejection of the jet of air are perpendicular to one another. Such an angle between these two directions makes it so that the two jets impede one another only slightly, if at all, and therefore that the jet of air and the jet of liquid remain as effective as possible.

As illustrated by FIGS. 1 to 4, the lens 110 may be circular. The cleaning device 1 is then configured to adapt around this circular lens 110. To this end, the base 3 may notably be curved and have an axis of curvature that is concentric with the axis of revolution A of the lens 110.

Preferably, the relative direction of ejection of the liquid and the relative direction of ejection of the jet of air both pass through the axis of curvature of the base 3. The jet of air and the jet of liquid therefore pass through the center of the surface of the lens 110 and can effectively clean the entire surface in line with the field of vision of the optical element 100.

According to a first embodiment that is not depicted, the base 3 may have the shape of an arc of a circle configured to partially surround the lens 110 of the optical element 100.

According to a second embodiment illustrated in FIGS. 1 to 4, the base 3 may have a circular shape configured to completely surround the lens 110 of the optical element 100. The base 3 of the cleaning device 1 then has an annular shape able to surround the lens 110. The lens 110 of the optical element 100 is then fitted into the annulus formed by the base 3, thus facilitating the mounting.

FIG. 5 shows a flow diagram of the different steps of a method for cleaning an optical element 100 comprising a cleaning device 1 as described above.

According to a first step 301, a jet of air is projected continuously onto the surface of the lens 110 by way of the air outlet 52. The fact that this jet of air is continuous, notably in the form of an air knife, makes it possible to protect the surface of the lens 110 and limit the deposition of dust and dirt.

During a second step 302, a jet of cleaning liquid is projected onto the surface of the lens 110 by way of the liquid outlet 62. During this second step 302, the intensity of the jet of air decreases such that the jet of cleaning liquid can reach the surface of the lens 110 and spread over its entire surface. This jet of liquid makes it possible to clean the surface of the lens in order to remove any dust and dirt.

This second step 302 may be triggered for example by a user who notices that the image returned by the optical element 100 shows dirt. This second step 302 may also be triggered automatically by a management device of the motor vehicle on the basis of an analysis of the image or periodically.

During a third step 303, the jet of liquid is interrupted and the jet of air picks up in intensity in order to discharge the cleaning liquid that may still be present on the surface of the lens 110 at the end of the second step 102. The jet of air is then maintained until a new second step 102 of ejecting cleaning liquid.

Thus, it is clear that the cleaning device 1 makes it possible, due to the presence of an air outlet 52 and of a liquid outlet 62, to effectively clean the surface of the lens 110 of an optical element 100. In addition, the fact that these two outlets 52 and 62 are combined within a common base 3 allows mounting of the cleaning device 1 on the optical element 100, and also mounting of the optical element 100 itself within the motor vehicle, to be effected more easily.

1. A cleaning device for an optical element configured to be fitted to a motor vehicle, said cleaning device comprising:
a base configured to be disposed on at least one of the sides of the lens of the optical element, said base comprising an air line in which a jet of air is intended to circulate between an air intake and an air outlet which are provided within said base, the air outlet protruding from the base and forming a first, air ejection nozzle which is disposed at the periphery of the lens of the optical element and which is configured to project a jet of air onto the surface of the lens;
a liquid line which is coupled to the base and in which a cleaning liquid is configured to circulate between a liquid inlet and a liquid outlet, the liquid outlet protruding from the base and forming a second, liquid ejection nozzle which is disposed at the periphery of the lens of the optical element and which is configured to project a jet of cleaning liquid onto the surface of the lens.

2. The cleaning device as claimed in claim 1, characterized in that the air outlet of the first nozzle and the liquid outlet of the second nozzle are disposed with respect to one another in such a way that the relative direction of ejection of the liquid forms an angle (α) of between 70° and 110° with respect to the relative direction of ejection of the jet of air.

3. The cleaning device as claimed in claim 1, wherein, the base comprises at least one curved portion configured to surround at least a part of the lens.

4. The cleaning device as claimed in claim 1, wherein the air outlet is configured such that the jet of air is an air knife, the air outlet having the shape of a slot.

5. The cleaning device as claimed in claim 1, wherein the device is configured to adapt around a circular lens, the base being curved and having an axis of curvature configured to be concentric with the axis of revolution of the lens of the optical element.

6. The cleaning device as claimed in claim 4, wherein the relative direction of ejection of the liquid and the relative direction of ejection of the jet of air both pass through the axis of curvature of the base.

7. The cleaning device as claimed in claim 1, wherein the base is configured such that only the air outlet and the liquid outlet project beyond the plane formed by the surface of the lens of the optical element.

8. The cleaning device as claimed in claim 1, further comprising a supply tube connected, for the one part, to the air intake of the base, and, for the other part, to a blower.

9. The cleaning device as claimed in claim 1, wherein the liquid inlet of the base comprises a device for connecting to a circuit for circulating a cleaning liquid of the motor vehicle.

10. An optical element configured to be fitted to a motor vehicle, said optical element comprising a cleaning device as claimed in claim 1.

11. A method for cleaning an optical element as claimed in claim 10 claim, said cleaning method comprising:
projecting a jet of air continuously onto the surface of the lens by way of the air outlet;
projecting a jet of cleaning liquid onto the surface of the lens by way of the liquid outlet, during which, the intensity of the jet of air decreases; and
interrupting the jet of liquid so that the jet of air picks up in intensity, said jet of air being maintained until ejecting the cleaning liquid.
